(19) United States
(12) Patent Application Publication
(10) Pub. No.: US 2006/0196294 A1
(43) Pub. Date: Sep. 7, 2006

(54) Fixing device for a magnetic ring on a gear in particular in a motor reducing gear

(76) Inventor: Jean-Emmanuel Berge, Poitiers (FR)

Correspondence Address: OSHA LIANG L.L.P., 1221 MCKINNEY STREET, SUITE 2800, HOUSTON, TX, 77010, US

(21) Appl. No.: 10/567,013

(22) PCT Filed: Jun. 26, 2004
(86) PCT No.: PCT/EP04/08337

§ 371 Date: Feb. 1, 2006

(30) Foreign Application Priority Data
Aug. 1, 2003 (FR) 0309623

(51) Int. Cl. F16H 1/16

(52) U.S. Cl. 74/425

(57) ABSTRACT

The invention relates to a fixing device (1), for a multipolar magnetic ring (10) on a gear (20), driven in axial rotation by an electric motor and, in particular, on a motor reducing gear. The invention is characterised in that the fixing device (1) comprises at least one stop element (22a, 22b), fixed to the gear (20), which can engage with an anchor projection (12a, 12b) on the magnetic ring (20), with a coupling direction essentially parallel to the plane of the gear (20), with at least one retaining clip (23) on the gear (20), which engages with a retaining projection (13) on the magnetic ring (20), after elastic deformation, with a coupling direction essentially perpendicular to the plane of the gear (20).

This invention relates to a fixing device that enables a multipolar magnetic ring to be fixed to a gear intended to be driven in axial rotation by an electric motor, in particular, on a motor reducing gear.

The invention has a particularly advantageous, but not exclusive, application in the field of windscreen-wiper mechanisms for motor vehicles.

There is a known way of using a multipolar magnetic converter to determine the angular position and or the speed of rotation of the output shaft of a motor reducer. The converter is generally presented in the shape of a ring, which is magnetised so as to have alternating north and south areas, and which is concentrically attached to the output shaft of the reducer. The principle then consists, with the help of a fixed magnetic sensor, for example using the Hall effect, of detecting the fronts of field change in the ring over time when the support gear is in rotation, and then of extrapolating the values of the sought parameters.

The main techniques used nowadays for solidly attaching a multipolar magnetic ring to the output gear of a motor reducer are gluing, over-moulding, setting and fixing with clips.

In the practice, however, gluing turns out to be a complicated process to implement insofar as it is always delicate to manipulate the glue and it is not at all easy to maintain a gluing machine. Maintaining the glue at a specific temperature constitutes a further obstacle to the widespread use of this assembly technique.

Over-moulding also has major drawbacks. One of such drawbacks has to do with it being almost necessary to perform the magnetisation of the ring during the moulding phase of the gear, if the aim is to have access to maximum-intensity magnetic fields. And yet, in the practice, this double operation turns out to be particularly difficult to implement under these specific conditions, and it also requires specific, expensive tools. Another disadvantage can be seen in the fact that the gear and the magnetic ring are generally made from a plastic material. And yet, for various technical reasons to do mainly with the moulding quality, strength and resistance to temperatures, contact and/or noise, the respective plastics used are generally of different natures. They do not therefore have the same melting temperatures, which considerably complicates the implementation of the moulding process by injection.

As for setting, it constitutes a fixing technique that is always difficult to perfect. Any inaccuracy, no matter how small, can in fact rapidly turn out to be incompatible with the intrinsic fragility of the magnetic rings. Moreover, additional tools are required, which in turn leads to increased costs. None of this obviously contributes to the general implementation of such an assembly process.

The use of clips is not a convincing fixing technique either, insofar as this method entails systematic free play due to the manufacturing tolerances. The magnetic ring cannot therefore be completely immobilised on the gear, unless it is restrained at the level of the fixings. But in these conditions, the concentration of considerable pressure stresses in well-localised areas of the magnetic ring, combined with the intrinsic fragility of the latter, is likely to result in breakages.

Consequently, the technical problem to be solved, according to the objective of this invention, is to provide a fixing device for a multipolar magnetic ring on a gear intended to be driven in axial rotation by an electric motor, in particular on a motor reducer gear, a fixing device that would make it possible to overcome the problems with the current technique by providing mainly a reliable attachment that is easy to implement, while guaranteeing the integrity of the magnetic ring.

The solution to the technical problem posed consists, according to this invention, in that the fixing device comprises at least one stop element on the gear, which can engage with an anchor projection on the magnetic ring, with a coupling direction essentially parallel to the plane of the gear, as well as at least one retaining clip on the gear, which engages with a retaining projection on the magnetic ring, after elastic deformation, with a coupling direction essentially perpendicular to the plane of the gear.

The invention as described above relates to all types of multipolar magnetic rings, both open and completely circular.

The invention is also applicable to any gear that is likely to be driven in axial rotation by an electric motor, regardless of whether said gear is coupled directly or indirectly with said electric motor. In this second hypothesis, the gear can, in particular, be an integral part of a reducer responsible for reducing the speed of the electric motor. It can also be mounted upstream or downstream from the reducer in question and/or from any other additional transmission means.

This invention also relates to the characteristics that will become apparent during the following description, and which should be considered in isolation or according to all their possible technical combinations.

This description, provided as a non-exhaustive example, will make it easier to understand how the invention might be carried out, in reference to the appended drawings, in which:

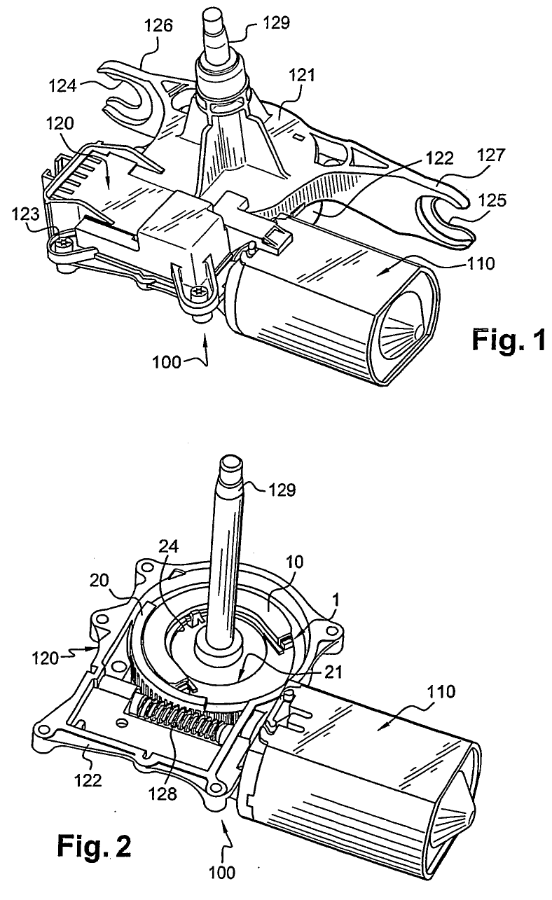

FIG. 1 shows a perspective view of a motor reducer intended to equip the windscreen-wiper mechanism of a motor vehicle.

FIG. 2 is a similar view to FIG. 1, with the reducer part open.

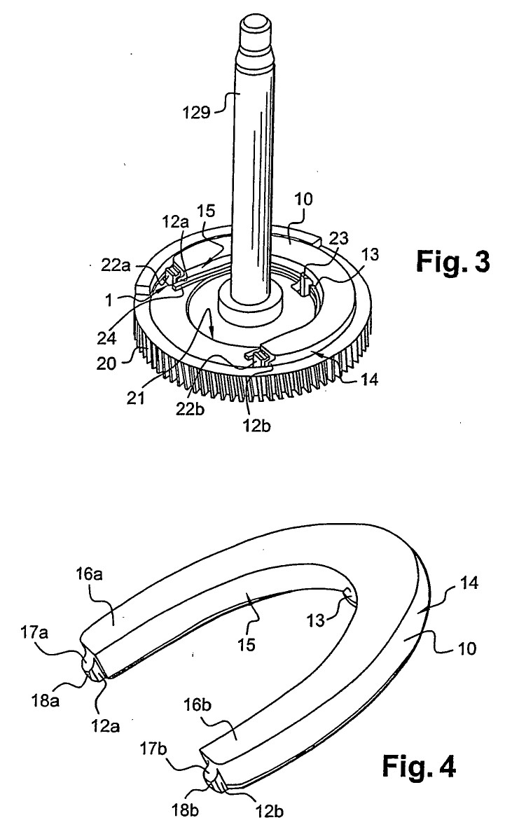

FIG. 3 shows in greater detail the mobile assembly that can be seen in FIG. 2, and which consists of a gear coupled with an output shaft on the one hand and with a magnetic ring on the other.

FIG. 4 shows a perspective view of the magnetic ring shown in FIG. 3.

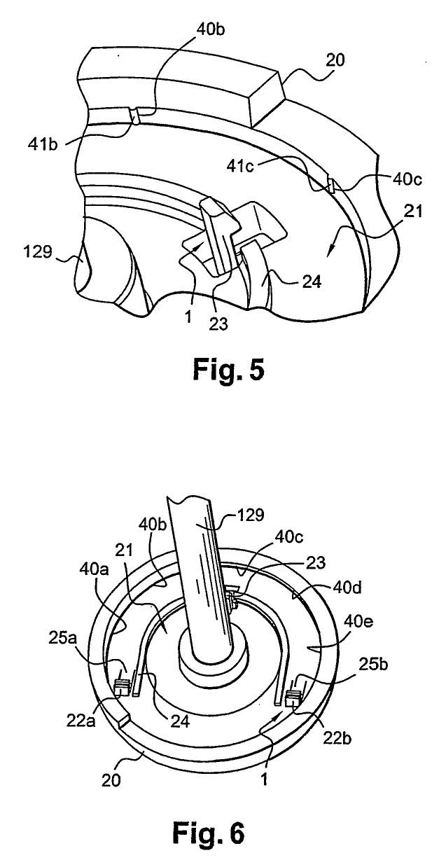

FIG. 5 shows a section of the top face of the gear, which is located at the level of the retaining clip.

FIG. 6 is a top perspective view of the gear coupled with the output shaft.

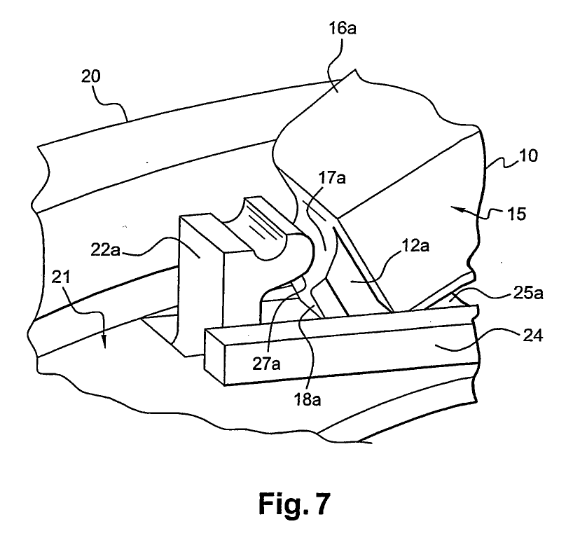

FIG. 7 also shows a section of the top face of the gear, which is located at the level of a stop element.

For the purpose of clarity, identical references have been used to designate elements that are the same. Likewise, only the elements that are essential for understanding the invention are shown, and are done so without respecting scale and in a diagrammatic fashion.

FIG. 1 shows a motor reducer 100 intended for a windscreen-wiper mechanism of a motor vehicle. This mechanism consists essentially of an electric motor 110 to which a reducer 120 is coupled with the aim of reducing its speed.

It can be seen that the reducer 120 includes two cases 121, 122 that are fixed together by means of several assembly screws 123. In addition to its role as a protective element, the top case 121 also has the function of acting as a support for fixing the windscreen-wiper mechanism to the body of the motor vehicle. Two housings 124, 125 are in fact placed on two different tabs 126, 127 so as to receive standard fixing dampers, not shown here for obvious reasons of clarity.

As can be seen in FIG. 2, the bottom case 122 is, above all, designed for supporting all the internal components of the reducer 120. It should be noted, in particular, that it contains a worm 128 which can be driven in axial rotation directly by the electric motor 110, as well as a sprocket 20 fixed to an output shaft 129 mounted such as to rotate around an axis that is essentially perpendicular to the axis of rotation of the worm 128. The assembly is arranged such as for the worm 128 to cooperate by meshing with the sprocket 20, so that the output shaft 129 can be driven indirectly in axial rotation by the electric motor 110.

It should also be noted that the sprocket 20 supports a multipolar magnetic ring 10, which is fixed flat against the top face 21 of said gear 20, by means of a fixing device 1. Moreover, the magnetic ring 10 is positioned concentrically in relation to the axis of rotation of the gear 20, and consequently in relation to the output shaft 129.

It should be noted that the magnetic ring 10 in this case is of the open type, since this shape adapts perfectly to use in the motor reducer 100 of a windscreen wiper. In this kind of application, the electric motor 110 is, in fact, of the reversible type and the angular amplitude of the shaft 129 at the output of the reducer 120 practically never exceeds 180°. This open shape also proves to be particularly advantageous at the time of mounting, since it allows the magnetic ring 10 to be brought closer to the gear 20, without being blocked by the output shaft 129.

FIG. 3 shows, more particularly, the mobile assembly that makes up the gear 20 coupled with the output shaft 129 on the one hand and with the magnetic ring 10 on the other.

In accordance with the objective of this invention, the gear 20 is provided with two stop elements 22a, 22B and a retaining clip 23, while the magnetic ring 10 is provided with two anchor projections 12a, 12b and a retaining projection. The assembly is arranged so that, on the one hand, both the stop elements 22a, 22b are respectively able to engage with the two anchor projections 12a, 12b, with a coupling direction that is essentially parallel to the plane of the gear 20 and, on the other hand, so that the retaining clip 23 is able to engage, after elastic deformation, with the retaining projection 13, with a coupling direction that is essentially perpendicular to the plane of the gear 20.

In this description, coupling direction is used to refer to the relative direction according to which the magnetic ring 10 should be brought closer to the gear 20 so as to make effective the implementation, depending on each case, of the stop elements 22a, 22b or of the retaining clip 13.

In the embodiment of the invention shown in FIGS. 1 to 7, the magnetic ring 10 is thus open and the two anchor projections 12a, 12b are respectively fixed to each of its free ends 16a, 16b. As for the retaining projection 13, is it positioned essentially at equal distances from the anchor projections 12a, 12b.

According to a particularly advantageous embodiment of the invention, each anchor projection 12a, 12b and each retaining projection 13 is fixed to the same side wall of the magnetic ring 10, regardless of whether it is the outside wall 14 or the inside wall 15. Moreover, each retaining projection 13 is positioned essentially opposite at least one anchor projection 12a, 12b. This means, therefore, that each retaining clip 23 is positioned essentially opposite at least one stop element 22a, 22b. This characteristic makes it possible, advantageously, to immobilise the magnetic ring 10 against the gear 20, using nothing but the stop elements 22a, 22b and the retaining clips 23.

However, this is not the case in the specific embodiment chosen here to illustrate the invention. The retaining projection 13, in fact, extends essentially in the same direction as the anchor projections 12a, 12b so that the radial immobilisation of the magnetic ring 10 in relation to the gear 20 is not guaranteed by the combination of the stop elements 22a, 22b and the retaining clip 23.

This is why, according to a particularity of the invention that can be seen mainly in FIG. 5, the fixing device 1 is provided, among others, with at least one clamping element 40a, 40b, 40c, 40d, 40e fixed to the gear 20, which can exert an essentially radial pressure stress on a side wall 14, 15 of the magnetic ring 10. It is understood that the fixing device 1 can include one or several clamping elements 40a, 40b, 40c, 40d, 40e placed with regard to the inner side wall 15.

In a particularly advantageous fashion, the fixing device 1 is equipped with at least one clamping element 40a, 40b, 40c, 40d, 40e, the pressure stress of which is guided essentially in the coupling direction of at least one anchor projection 12a, 12b with the relevant stop element 22a, 22b. This characteristic makes it possible to guarantee the radial immobilisation of the magnetic ring 10 against the gear 20.

According to FIG. 5, each clamping element 40a, 40b, 40c, 40d, 40e in this case consists of an elastically deformable outgrowth, the distal part 41b, 41c of which can cooperate by contact with the outer side wall 14 of the magnetic ring 10.

As can be seen in FIG. 6, in this embodiment of the invention, the fixing device 1 is provided with five clamping elements 40a, 40b, 40c, 40d, 40e, which are evenly spaced across the entire length of the side wall 14 of the magnetic, ring 10. Thus, in more general terms, the clamping elements 40a, 40b, 40c, 40d, 40e positioned with regard to the same side wall 14, 15, are advantageously distributed evenly opposite the entire length of said side wall 15, 16.

According to another particularity of the invention, each stop element 22a, 22b is able to exert an essentially axial pressure stress on the relevant anchor projection 12a, 12b, when each retaining clip 23 cooperates with the relevant retaining projection 13. This characteristic makes it possible to pin the magnetic ring 10 perfectly against the gear 20, and thus advantageously to avoid problems of free play.

According to FIGS. 4 and 7, each anchor projection 12a, 12b has an axial bearing surface 17a, 17b that is tilted downwards in relation to the plane of the magnetic ring 10. This means, in other words, that the top part of each anchor projection 12a, 12b, on which the relevant stop element 22a, 22b will exert its pressure stress, is bevelled from top to bottom, and increasingly so the closer one gets to its distal end 18a, 18b.

As can be seen in FIG. 7, each stop element 22a, 22b is provided with a concave axial bearing surface 27a, 27b, while the axial bearing surface 17a, 17b of each anchor projection 12a, 12b is essentially flat. This characteristic guarantees linear contact between the axial bearing surface 27a, 27b of each stop element 22a, 22b and the axial bearing surface 17a, 17b of the relevant anchor projection 12a, 12b. It should be noted that the fact that the axial bearing surface 17a, 17b is essentially flat means that it can be completely flat or slightly convex, or even very slightly concave.

According to another particularity of the invention, which can be seen in FIGS. 4 and 7, the height of each anchor projection 12a, 12b is essentially lower than the height of the magnetic ring 10 and, furthermore, said anchor projection 12a, 12b is fixed to the bottom of said magnetic ring 10. This characteristic makes it possible to clear a maximum amount of vertical space of each anchor projection 12a, 12b. The relevant stop element 22a, 22b is thus perfectly able to come over the projection in order to carry out the engagement and to exert the axial pressure stress, although without encroaching on the space located above the top 16 of the magnetic ring 10. The integrity of the magnetic sensors, which are associated with the magnetic ring 10, is therefore advantageously preserved.

According to another particularity of the invention, which can also be seen in FIGS. 4 and 7, the distal part 18a, 18b of each anchor projection 12a, 12b is bevelled so as to facilitate its insertion in the relevant stop element 22a, 22b.

As can be seen mainly in FIGS. 2 and 3 and 5 to 7, the fixing device 1 is also provided with a guiding lip 24 that is fixed to the gear 20, and which in this case is essentially complementary to the inner side wall 15 of the magnetic ring 10. It is notable that this guiding lip 24 is advantageously positioned with regard to the side wall 15 which is not intended to cooperate by contact with the clamping elements 40a, 40b, 40c, 40d, 40e so as to also be able to act as a stop.

In order to facilitate the installation of the magnetic ring 10 on the gear 20, in particular when a guiding lip 24 is made on the top face 21 of said gear 20, the bottom face of said magnetic ring 10 is bevelled on the outside and on the inside (FIG. 7).

According to another particularity of the invention, which can be seen particularly in FIGS. 6 and 7, each stop element 22a, 22b is placed at the end of a recess 25a, 25b which is able to guide the engagement of the relevant anchor projection 12a, 12b when the magnetic ring 10 is tilted in relation to the plane of the gear 20.

It is obvious that the invention also relates to any gear 20 intended to be driven in axial rotation by an electric motor 110, supporting a multipolar magnetic ring 10, and comprising at least one fixing device as described previously.

The invention also relates to any motor reducer 100 equipped with at least one such gear 20.

Furthermore, the invention relates to any windscreen-wiper mechanism equipped with at least one such motor reducer 100.

Finally, the invention relates to any motor vehicle comprising at least one such windscreen-wiper mechanism.

1. A fixing device for a multipolar magnetic ring on a gear intended to be driven in axial rotation by an electric motor, wherein the fixing device comprises at least one stop element fixed to the gear, which can engage with an anchor projection on the magnetic ring with a coupling direction essentially parallel to the plane of the gear, and at least one retaining clip on the gear, which can engage, after elastic deformation, with a retaining projection on the magnetic ring, with a coupling direction essentially perpendicular to the plane of the gear.

2. The fixing device according to claim 1, wherein each anchor projection and each retaining projection is fixed to the same side wall of the magnetic ring and in that each retaining projection is positioned essentially opposite at least one anchor projection.

3. The fixing device according to claim 1, wherein the magnetic ring is open and comprises two anchor projections, each of which is respectively fixed to each of its free ends and a retaining projection positioned essentially at the same distances from said anchor projections.

4. The fixing device according to claim 1, wherein each stop element is able to exert an essentially axial pressure stress on the relevant anchor projection, while each retaining claim cooperates with the relevant retaining projection.

5. The fixing device according to claim 4, wherein each anchor projection comprises an axial bearing surface which is tilted downwards in relation to the plane of the magnetic ring.

6. The fixing device according to claim 5, wherein each stop element comprises a concave axial bearing surface, and in that the axial bearing surface of each anchor projection is essentially flat.

7. The fixing device according to claim 1, wherein the height of each anchor projection is essentially lower than the height of the magnetic ring, and in that said anchor projection is fixed to the bottom of said magnetic ring.

8. The fixing device according to claim 1, wherein the distal part of each anchor projection is bewelled.

9. The fixing device according to claim 1, further comprising at least one clamping element fixed to the gear, which can exert an essentially radial pressure stress on a side wall of the magnetic ring.

10. The fixing device according to claim 9, further comprising at least one clamping element, the pressure stress of which is guided essentially in the coupling direction of at least one anchor projection with the relevant stop element.

11. The fixing device according to claim 9, wherein each clamping element consists of an elastically deformable outgrowth, the distal part of which can cooperate by contact with the relevant side wall of the magnetic ring.

12. The fixing device according to claim 9, wherein the clamping elements positioned with regard to the same side wall are distributed evenly with regard to the entire length of said side wall.

13. The fixing device according to claim 1, further comprising at least one guiding lip fixed to the gear, which is essentially complementary to a side wall of the magnetic ring.

14. The fixing device according to any claim 1, wherein the bottom face of the magnetic ring is bevelled on the inside and on the outside.

15. The fixing device according to claim 1, wherein each stop element is made at the end of the recess which can guide the engagement of the relevant anchor projection, while the magnetic ring is tilted in relation to the plane of the gear.

16-19. (canceled)

20. A motor reducer comprising:
a gear comprising a retaining clip;
a multipolar magnetic ring, wherein the multipolar magnetic ring is supported by the gear and comprises an anchor projection and a retaining projection; and
a fixing device a stop element fixed to the gear,
wherein the gear is configured to engage the anchor projection with a coupling direction essentially parallel to the plane of the gear,
wherein the at least one retaining clip is configured to engage the retaining projection with a coupling direction essentially perpendicular to the plane of the gear.
